(19) United States
(12) Patent Application Publication
(10) Pub. No.: US 2007/0013493 A1
(43) Pub. Date: Jan. 18, 2007

(54) Multi-functional monitor

(76) Inventor: Ching D. Liaw, Taipei Hsien (TW)

Correspondence Address: Ching D. Liaw, 235 Chung - Ho, Box 8-24, Taipei, TW

(21) Appl. No.: 11/183,097

(22) Filed: Jul. 18, 2005

(51) Int. Cl. B60R 25/10

(52) U.S. Cl. 340/426.1

(57) ABSTRACT

A multi-functional monitor utilizes a CCD camera to record the image of the head of a person. The image is then transmitted to an image processor (or a human-image recognition processor) for producing pixels of luminosity data of the image. Eventually, the pixel data are put into a central processing unit (CPU) wherein they are checked against a normal data for consistency. If they are not consistent or the person is determined to have an exceedingly high body temperature, the central processing unit (CPU) will control a driver to start a video recorder. Meanwhile, a relay will be activated to turn on a speaker and an LCD for warning the person and showing the body-temperature reading of the person. If the person continues to force in, the central processing unit (CPU) will notify a police authority through an automatic alarm system. It also warns the person with a flash light.

### FIELD OF THE INVENTION

The present invention relates to multi-functional monitors, more particularly to a multi-functional monitor comprising a CCD camera and at least a mirror for transmitting the head image of a person to a central processing unit (CPU) and a temperature sensor. The image is then transmitted to an image processor for producing pixels of luminosity data of the image, whereby the facial coverage or the temperature distribution can be determined by a central processing unit (CPU) and a temperature sensing unit. If the person is determined has suspicious facial coverage or an exceedingly high body temperature, the central processing unit (CPU) will activate a video recorder, a speaker for warning the person and an LCD for showing the body-temperature reading of the person. If the person continues to force in, the central processing unit (CPU) will notify a police authority through an automatic alarm system. It also warns the person with a flash light.

### BACKGROUND OF THE INVENTION

A monitor of the prior art, as shown in FIG. 1, takes the image of a person by a monitor unit (A) and then transmits the image into a display unit (B). The multi-functional monitor can also store the images of what it had viewed, providing a clerk of a shop the images of suspicious guests. The clerk can also push the button to notify a police authority, whereby preventing possible crimes against the valuables of the shop.

However, the display unit (B) can show only the situations at the scene and cannot pick up a suspicious guest for precaution measures, leading to the exposure of clerks, the boss and other customers in a dangerous situation. A shop clerk has to push notifying button for police under a dangerous situation.

Besides the function of anti-crime, the world has become wary of epidemics, such as SARS. Therefore, it is necessary to block the entrance of a person who has a body temperature exceeding a predetermined value. Thereby, the possibility of interaction between the person and a shop clerk or other guests can be illuminated.

Further, a person who acquires another person's banking card and at the same time knows the password illegally can withdraw money from the bank account. To avoid his or her identity, the person who stole money from a bank account through a banking machine as described above has to use facial coverage, such as a hat, a mask and a pair of polarized glasses. The current monitor cannot identify a person with suspicious facial coverage and therefore cannot prevent stealing money from a bank account through a banking machine.

To sum up, the conventional monitor has disadvantages as follows.
1. Being unable to take precautions to suspicious persons.
2. Being unable to deny admission of guests with abnormal body temperatures to a shop.
3. Putting a shop clerk who is notifying the police in a dangerous situation.
4. Being unable to protect the customers already in a shop from the intrusion of a suspicious guest.
5. The necessity of continuous concentration on monitoring people.
6. Being unable to confine a suspicious person who wants to steal money from a bank account through a banking machine.

### SUMMARY OF THE INVENTION

Accordingly, the primary objective of the present invention is to provide a multi-functional monitor which utilizes a CCD camera to record the image of the head of a person. The image is then transmitted to an image processor (or a human-image recognition processor) for producing pixels of luminosity data of the image. Eventually, the pixel data are put into a central processing unit (CPU) wherein they are checked against a normal data for consistency. If they are not consistent or the person is determined to have an exceedingly high body temperature, the central processing unit (CPU) will control a driver to start a video recorder. Meanwhile, a relay will be activated to turn on a speaker and an LCD for warning the person and showing the body-temperature reading of the person. If the person continues to force in, the central processing unit (CPU) will notify a police authority through an automatic alarm system. It also warns the person with a flash light.

The various objects and advantages of the present invention will be more readily understood from the following detailed description when read in conjunction with the appended drawings.

### BRIEF DESCRIPTION OF THE DRAWINGS

FIG. 1 illustrates a multi-functional monitor of the prior art.

FIG. 2 illustrates the arrangement of a multi-functional monitor of the present invention.

FIG. 3 is a system block diagram of the present invention.

FIG. 4 illustrates the present invention applied to a banking machine.

FIG. 5 is a system block diagram of the present invention applied to a banking machine.

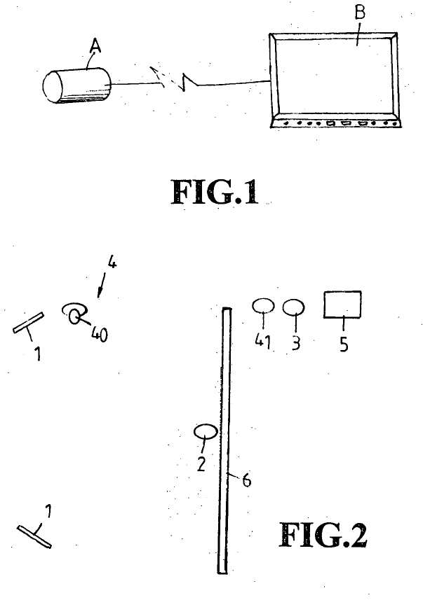

### DETAILED DESCRIPTION OF THE PREFERRED EMBODIMENTS

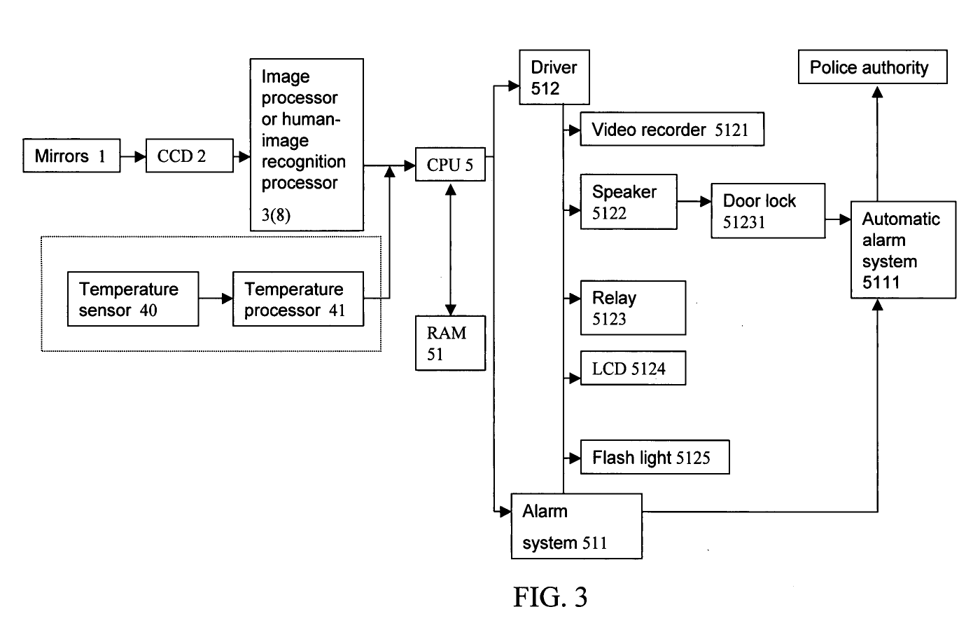

Referring to FIGS. 2 and 3, a multi-functional monitor according to the present invention comprises two mirrors 1, a CCD camera head 2, an image processor 3, a temperature sensing unit 4 and a central processing unit (CPU) 5. Those two mirrors 1 are respectively installed on the left and the right sides at a door or in front of an entrance gate, whereby the images of two lateral sides of the face of a person can be reflected to the CCD camera head 2. The temperature sensing unit 4 includes a temperature sensor 40 and a temperature processor 41, being installed in the positions similar to those of the mirrors 1 in front of a door or an entrance gate. The central processing unit (CPU) 5 is connected to a video recorder 5121, a speaker 5122, a relay 5123, a liquid crystal display (LCD) 5124 and a flash light 5125 through a driver 512. Thereby, the image of the face of a person entering a door will be reflected into the CCD camera head 2, and the image processor 3 will transformed the image into pixels, each containing the luminosity of the image at a pixel. The data in pixels are then sent into the central processing unit (CPU) 5 for analysis, or the data are sent to a human-image recognition processor 8 and then into the central processing unit (CPU) 5, whereby the covering articles on the face can be recognized. At the same time, the temperature over the face can be checked by the temperature sensor 40, and the body temperature can be derived by the temperature processor 41. The temperature data are also sent into the central processing unit (CPU) 5 for checking against a random-access memory (RAM) 51 data therein. If the measured temperature data and the stored are consistent, the person is admitted to entering the gate. If they are not consistent, the central processing unit (CPU) 5 will control an pre-existing alarm system 511 to notify the police, and meanwhile activate the driver 512 to start up the video recorder 5121, the relay 5123, a liquid crystal display (LCD) 5124 and a flash light 5125. The video recorder 5121 records the motion of the suspected person; the relay 5123 closes a door lock 51231 so that the person cannot enter the gate; the flash light 5125 will provide a repetitiously flashing light for warning; and the speaker 5122 will broadcast the reason why the person is denied admission to the gate and order him/her to take off his/her mask or hat or polarized glasses. For another purpose, the body temperature of the person is determined. If it exceeds a certain value, say 38° C., he or she will be asked to seek a doctor's help. If the person forces his/her way in, the automatic alarm system 511 will notify the police.

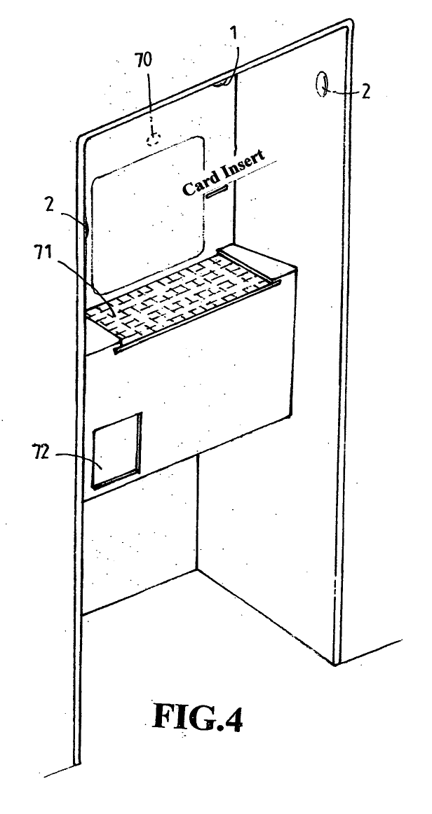

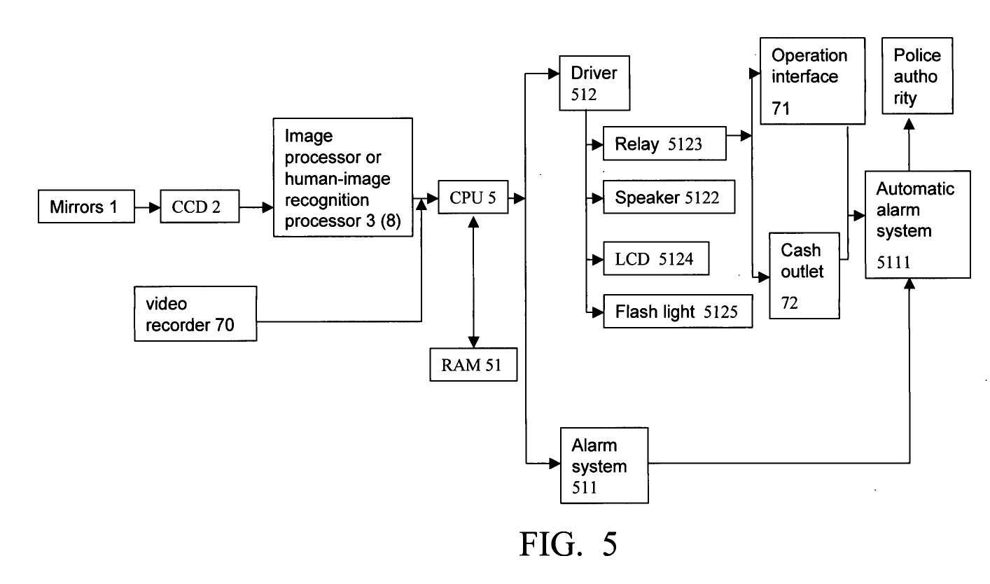

Referring to FIGS. 4 and 5, the present invention is applied to a banking machine. The multi-functional monitor comprises a mirror 1 and a CCD camera head 2 both disposed at proper locations around a banking machine 7. The multi-functional monitor further includes a image processor 3 and a central processing unit (CPU) 5 that are used with the mirror 1 and the CCD camera head 2 and are connected to a video recorder 70 of the banking machine 7. The mirror 1 reflects the image of the person who wants to withdraw money to a CCD camera head 2 or a plurality of CCD camera heads 2, so that the image processor 3 can transform the original image of the face of the person into luminosity data. Thereby, the central processing unit (CPU) 5 can check the measured data against a stored data set in the random-access memory (RAM) 51. If they are not consistent, the central processing unit (CPU) 5 will control an pre-existing alarm system 511 to notify the police, and meanwhile activate driver 512 to start up a relay 5123, a liquid crystal display (LCD) 5124 and a flash light 5125. The pre-existing video recorder 70 records the motion of the suspected person; the relay 5123 will shut off the operational operation interface 71 of the banking machine 7 and lock a cash outlet 72 of the banking machine so that the person cannot withdraw money; the flash light 5125 will provide a repetitiously flashing light for warning; and the speaker 5122 will broadcast the reason why the person is denied admission to the gate and order him/her to take off his/her mask or hat or polarized glasses. If the person damages the operation interface 71 or the lock of cash outlet 72 by force, the automatic alarm system 511 will notify the police for a timely arrest.

Referring to the figures, when a person comes in front of a gate, the mirrors 1 on two sides of the gate reflect the image of the face of the person into the CCD camera head 2. Further, the image processed by the image processor 3 will produce an image displaying the luminosity over the face. The distribution of luminosity will reflect the fact of the person's facial coverage, such as his/her polarized glasses, hat and mask. The luminosity image, in the form of a pixel matrix, will be checked against a stored data in the random-access memory (RAM) 51 of the central processing unit (CPU) 5, in accompany of a temperature sensing unit 4 for determining the body temperature of the person. If the measured temperature data and the stored are consistent, the person is admitted to entering the gate. If they are not consistent, the central processing unit (CPU) 5 will control an pre-existing alarm system 511 to notify the police, and meanwhile activate the driver 512 to start up the video recorder 5121, the relay 5123, a liquid crystal display (LCD) 5124 and a flash light 5125. The video recorder 5121 records the motion of the suspected person; the relay 5123 closes a door lock 51231 so that the person cannot enter the gate; the flash light 5125 will provide a repetitiously flashing light for warning; and the speaker 5122 will broadcast the reason why the person is denied admission to the gate and order him/her to take off his/her mask or hat or polarized glasses. For another purpose, the body temperature of the person is determined. If it exceeds a certain value, say 38° C., he or she will be asked to seek a doctor's help. If the person forces his/her way in, the automatic alarm system 511 will notify the police. Therefore, the present invention can be used in various occasions, as described above, and is indeed multi-functional.

To sum up, the present invention has the advantages as follows.
1. Measuring the body temperature of a guest entering a shop for the protection of other guests.
2. Blocking a person with suspicious facial coverage or a person with body temperature exceeding a predetermined value, say 38° C., entering a place.
3. Stopping a suspicious guest or a gust with body temperature exceeding a predetermined value, say 38° C., entering a shop by a first-level alarming system that notifying the police and a second-level alarming system that deters a guest from entering the shop and notifies the police if the person uses forces.
4. Automatically warning a suspicious guest or a gust with body temperature exceeding a predetermined value, say 38° C., by a speaker and a flash light.
5. Displaying a person's body temperature on a liquid crystal display (LCD).
6. Preventing a person with suspicious facial coverage, such as a mask and a pair of polarized glasses, from withdrawing money from a banking machine.
7. Transmitting the video signals to a police authority by the connection of the automatic alarm system of the present invention for quickly arresting a suspicious.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multi-functional monitor, comprising:
at least a mirror installed at a predetermined location in front of a door;
at least a CCD camera head, whereby a head image of a person who wants to enter through said door will be reflected by said mirror into said CCD camera head;
an image processor for receiving said head image and analyzing pixels thereof, whereby a luminosity according to each of said pixels will be determined;
a temperature sensing unit comprising a temperature sensor for measuring a body temperature over said head of said person via said luminosity data and a temperature processor for determining a body temperature of said person; and
a central processing unit for receiving said luminosity image from said image processor, determining facial coverage of said person and checking said measured image data against a standard image data stored in said central processing unit (CPU), said central processing unit (CPU) also receiving body temperature data from said temperature sensing unit for comparing with temperature data pre-stored therein.

2. The multi-functional monitor of claim 1 when one of facial coverage and body temperature is not consistent with said standard stored data, said central processing unit will activate both of a communication system to notify a police authority and a driver to start a video recorder, a speaker, a relay, an LCD and a flash light; thereby, said video recorder will register the motion of a suspicious person; thereby, said relay will lock a door; thereby, said flash light will be sending out a repetitious light to warn said person; thereby, said speaker will a reason why said person is denied admission to a place; said LCD will display a body temperature of said person, if said person has a body temperature exceeding a predetermined value, say 38° C.; if said person intends to force in, said door will activate an automatic alarm system that notifies said police authority as said door is being experiencing an external force.

3. The multi-functional monitor of claim 1 wherein said mirror and said CCD camera head can be replaced by a plurality of CCD camera heads, and wherein said image processor can be replaced by a human-image recognition processor; said central processing unit (CPU) can still determine abnormalities in facial coverage and body temperature.

4. The multi-functional monitor of claim 1 wherein said automatic alarm system transmits images of a suspicious scene to said police authority by a video connection, whereby said police will monitor said scene effectively and make an arrest timely.

5. The multi-functional monitor of claim 1 wherein said mirror and said CCD camera head are installed at a predetermined location around a banking machine for determining an abnormality in facial coverage and for warning a suspicious person by said speaker and said flash light; at the same time an operation interface and a cash outlet will be closed so that said person cannot withdraw money; if said person intends to damage said banking machine, said door will activate an automatic alarm system that notifies said police authority.
